(19) United States
(12) Patent Application Publication
(10) Pub. No.: US 2009/0044596 A1
(43) Pub. Date: Feb. 19, 2009

(54) FLOW CALIBRATOR

(76) Inventors: Harvey F. Padden, Montville, NJ (US); Edward Morrell, Randolph, NJ (US)

Correspondence Address: OSTROLENK FABER GERB & SOFFEN, 1180 AVENUE OF THE AMERICAS, NEW YORK, NY, 100368403, US

(21) Appl. No.: 12/188,757

(22) Filed: Aug. 8, 2008

Related U.S. Application Data
(60) Provisional application No. 60/956,470, filed on Aug. 17, 2007.

(51) Int. Cl. G01F 25/00

(52) U.S. Cl. 73/1.22

(57) ABSTRACT

A piston-and-cylinder gas flow calibrator (prover) having piston and cylinder elements with interface surfaces made of glass, quartz, or alumina. The piston and cylinder are made of the same material so as to have the same coefficient of thermal expansion. In one embodiment, the surface of the piston is ground, while the facing surface of the cylinder is unground. Also, disclosed are movement detectors for detecting movement of the piston in the cylinder.

### BACKGROUND OF THE INVENTION

1. Field of the Invention

The present invention relates to a piston-and-cylinder flow calibrator (prover), and more particularly to a flow calibrator having piston and cylinder elements with interface surfaces made of glass, quartz or ceramic materials.

2. Related Art

U.S. Pat. No. 5,440,925 discloses a high accuracy flow calibrator for testing and calibrating flowmeters and the like, and more particularly a positive displacement flow calibrator which may include a cylinder (12), a piston (10) within the cylinder (12) which makes a clearance seal with the inside of the cylinder, an encoder (40) associated with the piston, and a control valve (V) for controlling the supply of a fluid flow (A1) to be measured. See FIG. 1 of that patent. More generally, the flow calibrator includes a channel for receiving a fluid flow so as to move the piston (10) within its enclosure (12); and a device (36, 38, 40) for detecting movement of the piston and generating electrical signals representative of the fluid flow to be measured. The movement of the piston is detected as a function of a known volume of the enclosure traversed by the piston, and a measured variable elapsed time over which the piston traverses the volume.

Referring in more detail to FIG. 1, the '925 patent discloses a cylindrical piston 10, which is slidable within a cylinder 12 from a bottom position as shown, to a top position 10′. The piston and cylinder are enclosed within an outer tube 14, which has a top cover 16 and a bottom cover 18. The cylinder 12 is further supported by a lower support 20 and by a center section 22.

The lower support 20 has apertures or slots (not shown) to allow gas flow therethrough. A valve V is provided to open and close an opening between the interior of the center section 22 and the lower support 20. The valve V is shown open in FIG. 1.

Gas flow with the valve V open will now be described. Suction from a pump to be measured is applied to an outlet 28. Gas enters the flow calibrator through an inlet 24 and is filtered by a filter 30. The inlet flow path is indicated by an arrow A1. The gas follows the path of least resistance along an arrow A2, through the opening 26, and past the valve V, and exits the flow calibrator through the outlet 28 along a path indicated by an arrow A3.

If the valve V is closed, the opening 26 is blocked. The gas enters the center section 22 along path A1, follows a path indicated by an arrow A2′, and causes the piston 10 to displace upward toward the position indicated at 10′. Air within the cylinder 12 displaced upward within the cylinder and follows a path indicated by arrow A2″, to exit through the outlet 28.

The upward movement of the piston is limited by a rubber or elastomeric bumper 32 on the lower side of the top cover 16. An O-ring 33 serves as a bottom bumper for the piston 10.

Several of the components of the flow calibrator are sealed by conventional O-ring seals, as shown.

A sensor support 34 is mounted at the upper end of the center section 22. An optical interrupter assembly mounted on a support plate 35 of the sensor support 34 includes a light source 36 and a sensor 39 mounted in a yoke 38. See FIG. 1A of the '925 patent. An encoder strip 40 is attached to the piston 10 and moves upward and downward with it. The encoder strip contains a plurality of evenly spaced apertures 42 which alternately block and unblock a light path from the light source 36 to the sensor 39, which generates signals indicating the presence of the apertures 42 as they pass through the optical interrupter. Encoders having visible marks, magnetic encoders, and other types could be used as well. A suitable computing system is provided for processing data from the photodetector 39 indicating movement of the encoder strip 40, and calculating therefrom the flow rate of the flowing gas.

The disclosure of U.S. Pat. No. 5,440,925 is incorporated by reference in its entirety.

A highly advantageous feature is that the interfacing portions of the piston and cylinder may be made of the same material or similar materials so as to have the same coefficient of thermal expansion. For example, one interfacing portion may contain carbon and the other interfacing portion may contain glass. The carbon-containing surface may provide a self-lubricating function, if contact between the piston and cylinder should occur. Such contact is unexpected in the normal case, because the clearance seal forms an air bearing, whereby the piston tends to center itself in the cylinder. In another example, the cylinder may be made of borosilicate glass and the piston of graphite.

The instruments described and claimed in the '925 patent are distributed commercially by the BIOS International Corporation under the DryCal® name and have been highly successful.

This equipment has been found to be capable of at least 10⁴ cycles between failures. The lifetime of the graphite and borosilicate glass combination seems to be limited by the following factors:

The graphite piston surface is relatively brittle. Since neither the graphite surface nor the glass surface is infinitely smooth, the piston's high points tend to momentarily strike high points of the cylinder. Indeed, this has been the primary failure mode in actual service, generating debris that can jam the piston, particularly upon resetting to its downward position.

With a loss of graphite due to the above effect, the diameter of the piston may shrink (or on the other hand, if the cylinder is made of graphite, the cylinder's diameter may increase), increasing leakage and thereby reducing the measurement accuracy of the flow calibrator.

### SUMMARY OF THE INVENTION

It would accordingly be desirable to provide improved wear characteristics in a viscous (clearance)-sealed piston-cylinder flow calibrator, particularly by providing improved materials for the piston and/or the cylinder.

It would further be desirable to extend the mean time to failure of this device.

Addressing these issues, according to one embodiment, the inventors have found that significant advantages are obtained by providing interface surfaces that both comprise glass, and more particularly, by forming at least one interface surface of ground glass.

In one example, the piston has a ground glass surface, while the surface of the cylinder is unground glass. With this flow calibrator, mean time to failure has been demonstrated to reach 10⁶ cycles.

This finding is paradoxical, since interfaces between similar materials generally experience significant wear. Nevertheless, with these glass components, no wear, shedding or jamming and an extended lifetime are seen.

A notable advantage of this embodiment of the invention is that grinding is a convenient method of forming a glass piston with the intended size and shape. It is difficult to set the outer dimension of a glass piston, for example by heating and cooling, when it is formed in a mold. The grinding process can both set the size and shape of the piston, and provide a ground outer surface according to the advantageous features of the invention.

A further advantage is that since the piston and cylinder are made of the same material, they will have identical coefficient of thermal expansion, which eliminates any change with temperature of the clearance between the piston and the cylinder.

Yet another advantage is that the use of two glass surfaces eliminates electrostatic forces that may occur when two different materials are employed, as in the prior glass/graphite embodiment. Electrostatic forces would be undesirable, as such forces could cause increased friction and affect measurement accuracy.

An additional advantage is that while the use of graphite can result in changes in frictional characteristics, depending on the gas species being measured, experimental tests have shown that the frictional characteristics using glass elements do not change when different gas species are measured.

In other embodiments of the invention, the piston may be unground glass and the cylinder ground glass, or alternatively, both surfaces may be ground glass. These embodiments are expected to yield similar advantages.

It has been confirmed by the inventors that the use of the two glass surfaces improves the cyclindricity of both the piston and the cylinder. This improved cyclindricity makes possible a clearance seal no more than 10 microns across, leading to insignificant fluid leakage and essentially no friction.

According to further embodiments of the invention, flow calibrators having quartz elements and alumina elements (ground piston and unground cylinder) have also been constructed and tested by the inventors, and found to have the same advantages as described above. Additional embodiments having unground piston and ground cylinder, or having both surfaces ground, are expected to have similar advantages.

Other features and advantages of the present invention will become apparent from the following description of embodiments thereof, which refers to the accompanying drawings.

### BRIEF DESCRIPTION OF THE DRAWINGS

FIG. 1 is a cross-sectional view of a flow calibrator according a first embodiment of the invention.

FIG. 1A is a cross-sectional detail view of the encoder and optical sensor of the flow calibrator.

FIG. 2 is a schematic view of an alternate flow calibrator according to a second embodiment of the invention.

### DETAILED DESCRIPTION OF EMBODIMENTS OF THE INVENTION

A flow calibrator with a ground glass piston and an unground glass cylinder has been constructed and tested.

For reference (since conventional friction does not necessarily apply due to lack of perpendicular forces) the coefficient of friction of the ground surface is about 0.1, similar to that of graphite-on-graphite. The coefficient of friction of the unground surface is about 0.8, which is typical for glass. Surface roughness depth of the ground piston surface has been measured at about 0.25 to 1.0 μm. Surface roughness depth of the unground glass surface is negligibly or unmeasurably low.

According to alternate embodiments of the invention, the piston may be unground and the cylinder ground, or both surfaces may be ground.

According to further embodiments of the invention, as mentioned above, the piston and cylinder may be made of either quartz or alumina. Embodiments having ground piston surfaces and unground cylinder surfaces have been constructed and found to have the same advantages as those described above. Additional embodiments having unground piston and ground cylinder, or having both surfaces ground, are expected to have similar advantages.

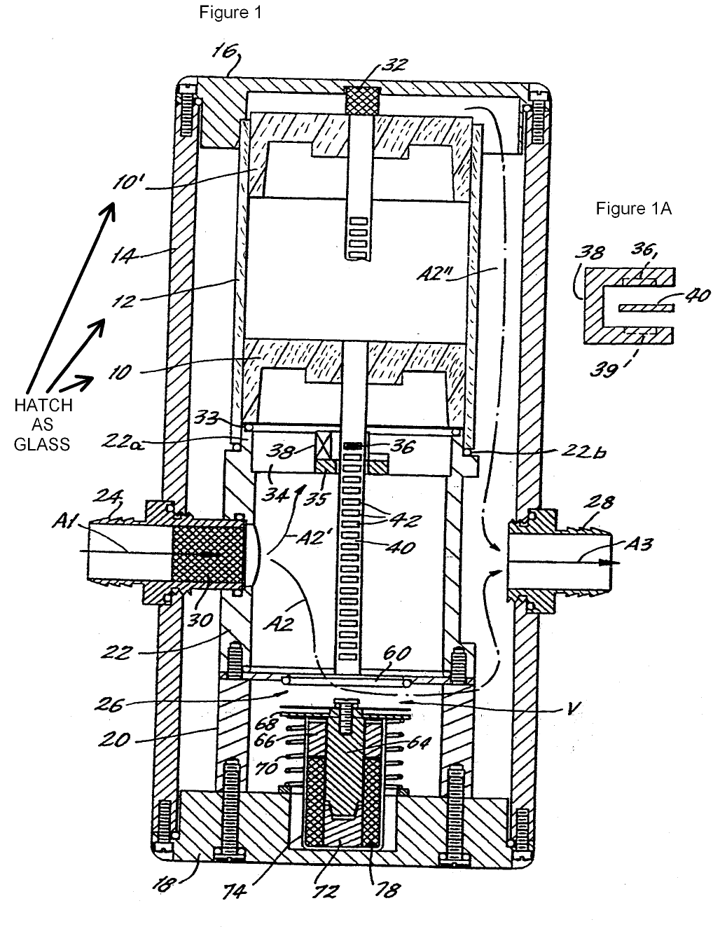

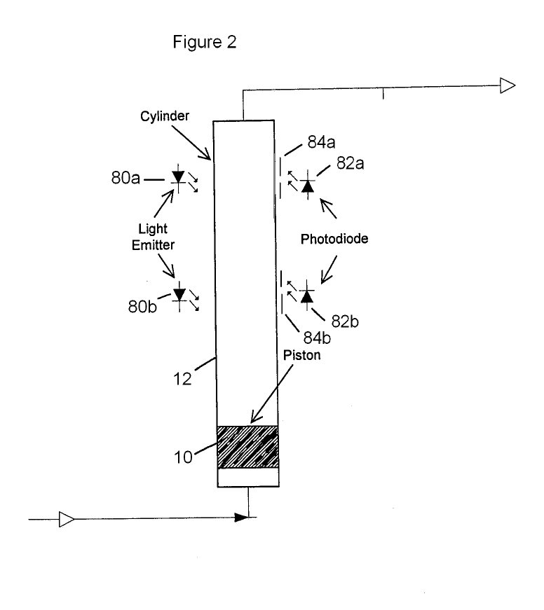

FIG. 1 is a cross-sectional view similar to that in FIG. 1 of the '925 patent, wherein the piston 10 and the cylinder 12 are hatched to indicate that the material is glass. Other elements and parts shown in FIG. 1 correspond to those described hereinabove and in the '925 patent, so their detailed description is omitted. FIG. 2 is a schematic view of an alternate flow calibrator according to a second embodiment of the invention. In this embodiment, the sensor support 34 and the optical interrupter assembly 36, 38, 40 and related elements of FIG. 1 may advantageously be eliminated and replaced by a simpler arrangement shown schematically in FIG. 2. As seen, a pair of light emitters 80a, 80b, which may be LED's for example, are disposed at predetermined positions along the length of the cylinder 12. On the opposite side of the cylinder 12, a pair of light receivers, e.g., photodiodes 82a, 82b and collimators 84a, 84b, are disposed for receiving the light from the LED's 80a, 80b, respectively. Movement of the piston 10 in the cylinder 12 is tracked in this case by sensing the times at which an edge of the piston breaks the two respective light paths between the light emitters and the corresponding light receivers, and processing that information as in the first embodiment of the invention.

Although the present invention has been described in relation to particular embodiments thereof, many other variations and modifications and other uses will become apparent to those skilled in the art. Therefore, the present invention is not limited by the specific disclosure herein.

1. A gas flow calibrator comprising:
an enclosure;
a piston movable within said enclosure, the piston and enclosure having respective interfacing surfaces forming a clearance (viscous) seal;
a channel for receiving a gas flow to be measured and directing said flow so as to move said piston within said enclosure; and
a movement detector for detecting movement of said piston and generating therefrom electrical signals representative of said gas flow to be measured;
wherein said respective interfacing surfaces of said piston and enclosure have the same coefficient of thermal expansion; and
wherein said interfacing surfaces each contain a material selected from the group consisting of glass, quartz and alumina.

2. A flow calibrator as in claim 1, wherein one of said surface materials is ground and the other of said surface materials is unground.

3. A flow calibrator as in claim 2, wherein the piston surface is ground and the cylinder surface is unground.

4. A flow calibrator as in claim 2, wherein the cylinder surface is ground and the piston surface is unground.

5. A flow calibrator as in claim 2, wherein both the cylinder and piston surfaces are ground.

6. A flow calibrator as in claim 1, wherein said material is glass.

7. A flow calibrator as in claim 1, wherein said material is quartz.

8. A flow calibrator as in claim 1, wherein said material is alumina.

9. A flow calibrator as in claim 1, wherein said movement detector comprises an encoder associated with said piston and a corresponding optical detector associated with said enclosure.

10. A flow calibrator as in claim 1, wherein said movement detector comprises a first light emitter/receiver pair and a second light emitter/receiver pair, said first and second emitter/receiver pairs being disposed at different respective positions along said enclosure for detecting the presence of the piston at said respective positions.
